(19) United States
(12) Patent Application Publication
(10) Pub. No.: US 2020/0318375 A1
(43) Pub. Date: Oct. 8, 2020

(54) FLOOD PROTECTION APPARATUS

(71) Applicants: John Leslie GREEN, (US); Timothy Gibbons CAMERON, (US)

(72) Inventor: John Leslie GREEN, London (GB)

(21) Appl. No.: 16/301,328

(22) PCT Filed: May 12, 2017
(86) PCT No.: PCT/GB2017/051327

§ 371 Date: Nov. 13, 2018

(30) Foreign Application Priority Data
May 13, 2016 (GB) 1608415.4

(51) Int. Cl. E04H 9/14; E06B 9/00

(52) U.S. Cl. CPC E04H 9/145; E06B 2009/007; E06B 2009/002; E06B 9/00

(57) ABSTRACT

Flood protection apparatus for temporarily blocking a building opening (30) to guard against the ingress of flood water. The apparatus comprises a collapsible bag (10) formed from a watertight conformable material and has a filling means (20) for admitting a flowable filling medium to the bag (10) to expand the bag (10) from a collapsed state. When the bag (10) is disposed in the building opening (30) and filled, the bag (10) conforms to and seals against a periphery of the building opening (30) under the pressure of the filling medium to define a sealing region (A) across the building opening (30). A pair of buttress regions (B) are disposed on front and rear sides of the sealing region (A). The weight of the filling medium in the buttress regions (B) acts to prevent displacement of the bag (10) from the building opening (30).

### FIELD OF THE INVENTION

The present invention relates to a flood protection apparatus. In particular, but not exclusively, the invention relates to a temporary barrier apparatus for blocking a building opening.

### BACKGROUND TO THE INVENTION

Flooding of domestic and commercial premises can lead to substantial damage to possessions, furnishings and buildings and often causes considerable distress and inconvenience to the occupiers of the affected premises. Flooding can also create health risks, both in the short term due to the contamination of flood water with sewage or other harmful materials, and in the longer term in cases where persistent dampness leads to the growth of moulds.

A multitude of products have been proposed to protect premises from flood damage. Many of these products aim to protect individual properties from flood damage by forming a temporary barrier across a building opening, such as a doorway, to prevent or substantially slow the ingress of water through the opening. The complexity, ease of installation, convenience and cost of these products varies substantially.

A traditional solution is the use of sandbags to construct a barrier across the doorway. The main advantage of sandbags is that they are low cost.

However, they are heavy and bulky, leading to transportation and storage difficulties. Although sandbags can be transported empty to a site and filled with locally-available sand or soil, the process of filling sandbags and moving them into position is labour-intensive, a source of filling material is required, and an element of training is required to construct an effective and safe barrier. Even when properly constructed, some seepage may occur through a sandbag barrier. The removal and disposal of used sandbags can also be difficult, particularly if they are waterlogged or contaminated with tainted flood water.

Bag-like products that do not require a source of sand or similar filling material have also been developed. Typically, these products comprise permeable bags filled with a lightweight absorbent material. The absorbent material swells and gels upon exposure to water, so that the volume of the bag increases considerably. The expanded bags can be used to construct a barrier in the same way as for sandbags. These products do not however address several of the other disadvantages of sandbags. In particular, once swollen, the bags are relatively heavy and moving them into position and removing them after use can be a slow and labour-intensive process, and careful placement of the bags is necessary to form an effective barrier.

Some alternative barrier products take the form of a removable panel that engages with a frame that is pre-fitted to the building around the doorway. When flooding is expected, the panel is inserted into the frame, and a seal is formed between the panel and the frame so that water cannot pass through the doorway. Whilst such systems can be relatively effective, the need to pre-install a frame to the doorway and the relatively high cost of these products mean that their use is typically restricted to properties that are at high risk of regular flooding, such as those that are close to a waterway or other body of water. Furthermore, the panels used in such products are typically relatively large and heavy, and can therefore present storage problems and may not be suitable for use by the elderly or infirm.

Barrier panels that do not require the permanent fixing of a separate frame to the doorway are also known. For example, European Patent Publication No. EP 0 978 624 B1 describes a barrier panel having an expandable internal frame that is covered with a waterproof stretchable membrane. The internal frame can be expanded so as to seal the edges of the panel against the doorway to form a temporary barrier. However, the internal complexity of these panels leads to a relatively high cost, and careful installation is required to avoid leakage and to prevent the panels being forced out of the opening by the pressure of water. Again, therefore, the suitability of these products for the elderly or infirm is limited.

Against this background, it would be desirable to provide a low cost, simple product that can be used to prevent or slow the ingress of flood water through a building opening.

It would also be desirable to provide a product that can be easily stored and deployed with minimal physical effort, and that can be easily removed and re-stored.

### SUMMARY OF THE INVENTION

From a first aspect, the present invention resides in a flood protection apparatus for temporarily blocking a building opening to guard against the ingress of flood water, comprising a collapsible bag formed from a watertight conformable material and having a filling means for admitting a flowable filling medium to the bag to expand the bag from a collapsed state, wherein, when the bag is disposed in the building opening in the collapsed state and filled with the filling medium, the bag conforms to and seals against a periphery of the building opening under the pressure of the filling medium to define a sealing region of the bag that spans across the building opening and a pair of buttress regions disposed on front and rear sides of the sealing region, and wherein the weight of the filling medium in the buttress regions acts to prevent displacement of the bag from the building opening.

Advantageously, the bag can be stored and transported in its collapsed state, in a lightweight and compact configuration. When required, the collapsed bag can be arranged in a building opening, such as a doorway, and then expanded in-situ by filling the bag with the filling material. Most conveniently, the filling medium is water. Because the bag is formed from a conformable material, upon expansion of the bag, the bag conforms to the shape of periphery of the building opening. In the resulting sealing region of the bag, the hydrostatic pressure of the filling medium acts to force the material of the bag into contact with the periphery of the opening, forming a tight seal to prevent leakage of flood water through the building opening past the expanded bag. The filling material also substantially increases the weight of the bag. Thus the buttress regions of the bag, which are arranged either side of the sealing region, support the sealing region and stand on the ground or flooring adjacent to the building opening to act as anchors or stays for the bag. This ensures that the bag remains in position in the building opening even when subject to substantial lateral loads from flood water.

With this arrangement, no modifications to the building opening or special fixings are required, and the apparatus can be used irrespective of the shape and arrangement of the building opening. This means that the apparatus can be used for blocking substantially any building opening for which the bag is suitably sized.

It will be appreciated that the term “blocking” is used herein to refer to the obstruction of at least a part of a building opening to prevent or substantially reduce the passage of flood water through the building opening. Complete blocking of the building opening is not essential, and in most practical situations only the bottom part of a building opening is blocked.

When the risk of flooding has passed, the filling medium in the bag can be drained to return the bag to its collapsed state, allowing the bag to be easily removed from the building opening and, optionally, stored for re-use. Thus the use of the apparatus does not require heavy lifting or significant manual labour.

The bag may include a drain means for draining the filling medium from the bag to collapse the bag for release from the building opening. The drain means may comprise a closable port. The drain means may be disposed on a front part of the bag, in which case a visual indication may be provided to denote the front part of the bag to assist a user in placing the bag in the appropriate orientation in the building opening, typically with the drain means on the outside of the building. The drain means is preferably at or adjacent to the bottom of the bag.

A visual indication may be provided to denote a midplane of the bag. The midplane preferably coincides with the widest part of the bag, and is vertically oriented. This indication can guide the user in arranging the bag in the building opening in an optimum position for forming a seal with the periphery of the building opening.

Preferably, the bag has a width of at least 1 m when the bag is expanded. In this way, the apparatus is suitable for use in the majority of external doorways in domestic properties, which are typically between 0.8 and 0.95 m in width. In one embodiment, the bag has a width of approximately 1.1 m.

Preferably, the distance between a frontmost point and a rearmost point of the bag (i.e. the depth of the bag) is at least half of the width of the bag when the bag is expanded. More preferably, the depth of the bag is substantially equal to the width of the bag when the bag is expanded. In this way, when expanded in the building opening, the buttress regions of the bag extend substantially beyond the doorway to anchor the bag and to support the sealing region to maintain the seal against the building opening. In a preferred embodiment, the bag is generally cylindrical. The height of the bag is preferably at least approximately 0.5 m, and more preferably the height of the bag is at least approximately 1 m.

The internal volume of the bag is therefore substantial, and is capable of holding a large mass of filling material to provide stability to the bag. For example, the bag may be capable of holding at least approximately 500 kg of water. More preferably, the bag may be capable of holding at least approximately 750 kg of water. In a preferred case, the bag has a diameter of 1.1 m and a height of 1 m, and is capable of holding approximately 950 kg of water.

The bag does not require any internal structure or framework that would otherwise add weight, cost and complexity to the apparatus. To this end, the bag may have a substantially continuous internal volume. The internal volume of the bag may be substantially uninterrupted. The bag may be self-supporting when filled with the filling medium.

In one embodiment, the bag comprises a base panel and a top panel connected to the base panel by a sidewall. The panels may be sealed to the sidewall by welding. The filling means may be disposed on the top panel of the bag. The filling means may comprise a closable filling port.

The bag preferably comprises vent means for the release of air. In this way, air in the bag can be expelled through the vent when the bag is filled. Conveniently, the vent means may be incorporated with or integral with the filling means.

Any suitable material can be used for the bag. For example, the material of the bag may comprise a polymeric sheet material. Preferably, the bag comprises at least one of polyester, polyethylene, polyvinyl chloride and/or rubber. In one example, the material of the bag comprises a biaxially-oriented polyethylene terephthalate material.

The apparatus may further comprise a filling hose cooperable with the filling means and connectable to a water supply. In this way, the apparatus provides a kit of parts that can be used to construct a temporary barrier in a building opening whenever a suitable water supply is available. The apparatus may comprise a domestic water tap connector, to connect the hose to a tap (faucet).

It will be appreciated that the sealing region and the buttress regions are defined primarily by the condition of the bag when in use, and that it is not necessary for these regions to be structurally or physically distinguished from one another. However, in an embodiment, the bag comprises a sealing region and a pair of buttress regions arranged on either side of the sealing region.

To that end, in another aspect of the invention, there is provided a flood protection apparatus for temporarily blocking a building opening to guard against the ingress of flood water, comprising a collapsible bag formed from a watertight conformable material and having a sealing region for spanning across the building opening, a pair of buttress regions disposed on front and rear sides of the sealing region, and a filling means for admitting a flowable filling medium to the bag to expand the bag from a collapsed state, such that, when the bag is disposed in the building opening in the collapsed state and filled with the filling medium, the sealing region conforms to and seals against a periphery of the building opening under the pressure of the filling medium, and the weight of the filling medium in the buttress regions acts to prevent displacement of the bag from the building opening.

The present invention also resides in a method of temporarily blocking a building opening to guard against the ingress of flood water, comprising arranging a bag in a collapsed state in the building opening, the bag being formed from a watertight conformable material, and filling the bag with a flowable filling medium to expand the bag, such that the bag conforms to and seals against the periphery of the building opening to define a sealing region of the bag that spans across the building opening and a pair of buttress regions of the bag disposed to the front and rear sides of the building opening.

Preferably, the filling medium is water, and the method may comprise connecting a hose to the bag to fill the bag. The method may further comprise draining the filling medium from the bag to collapse the bag for removal from the building opening.

The method may comprise orienting the bag in the building opening in accordance with an indicator on the bag and/or aligning an indicator on the bag with the building opening. In this way, the bag can be optimally aligned before it is filled. The bag may be generally cylindrical when expanded, and the method may comprise arranging the bag such that a diameter of the bag is aligned with the building opening.

Preferred and/or optional features of each aspect of the invention may be used, alone or in appropriate combination, in the other aspects of the invention also.

### BRIEF DESCRIPTION OF THE DRAWINGS

Embodiments of the present invention will now be described, by way of example only, with reference to the accompanying drawings, in which like reference numerals are used for like features, and in which:

FIG. 1 shows a flood protection bag according to an embodiment of the present invention in an expanded state;

FIGS. 2(a), 2(b), 2(c) and 2(d) show perspective, top, front and side views, respectively, of the bag of FIG. 1 in a collapsed state in situ in a doorway;

FIGS. 3(a), 3(b), 3(c) and 3(d) show perspective, top, front and side views, respectively, of the bag of FIG. 1 in a partially expanded state in situ in the doorway; and

FIGS. 4(a), 4(b), 4(c) and 4(d) show perspective, top, front and side views, respectively, of the bag of FIG. 1 in a fully expanded state in situ in the doorway.

### DETAILED DESCRIPTION OF EMBODIMENTS OF THE INVENTION

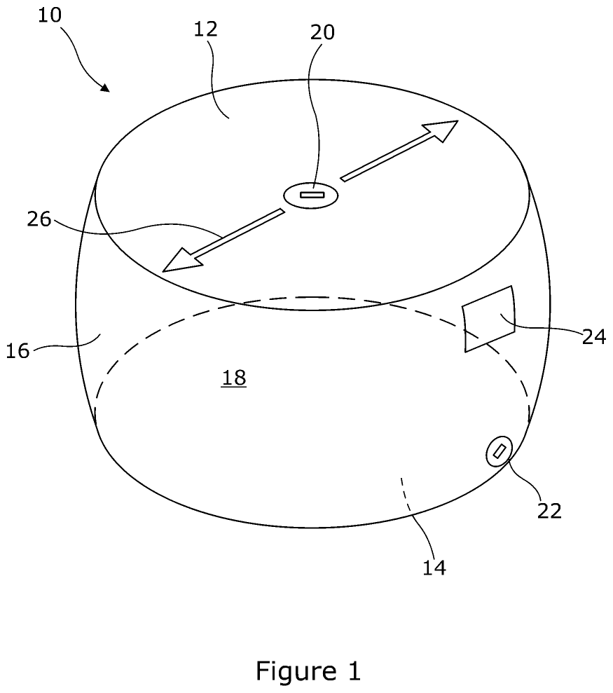

Referring first to FIG. 1, a flood protection apparatus according to an embodiment of the invention comprises a collapsible bag 10 with a generally cylindrical shape. The bag 10, which is shown in a fully expanded state in FIG. 1, is formed from a circular top panel 12, a circular base panel 14, and a tubular sidewall 16 that extends between and connects the top and base panels. The bag 10 therefore encloses an internal volume 18 for containing a filling medium.

A closable filling port 20 is provided in the centre of the top panel 12. A closable drain port 22 is provided in the sidewall 16, at the bottom of the front of the bag 10 (i.e. adjacent to the base panel 14). A label 24 is disposed on the front of the bag 10, to aid identification of the front of the bag 10 and the location of the drain port 22. Although not shown in FIG. 1, the filling port 20 incorporates a vent that allows air to leave the internal volume 18 of the bag 10 at least when the filling port 20 is open.

A pair of arrows 26 is printed on the top panel 12 of the bag 10. The arrows 26 indicate the position of a vertical midplane of the bag 10, which in this case corresponds to a diameter of the bag 10. The midplane is equidistant between the front of the bag (i.e. where the drain port 22 is situated) and the rear of the bag, opposite the drain port 22.

In this example, the bag 10 is dimensioned for use in a domestic doorway and is approximately 1.1 m in diameter. The height of the bag 10 (i.e. the distance between the top and base panels 12, 14) when the bag is fully expanded is approximately 1 m. The maximum internal volume 18 of the bag 10 is therefore approximately 0.95 cubic metres.

The filling port 20 can be used to admit a filling medium, such as water, to the internal volume 18 to expand the bag 10. FIG. 1 shows the bag when the internal volume 18 is filled with the filling medium. However, in practice, the bag 10 is supplied in a collapsed state, without filling medium in the internal volume 18. The collapsed bag 10 is compact, and can therefore be easily stored in domestic premises, and is lightweight to allow the bag 10 to be easily lifted and positioned by a user.

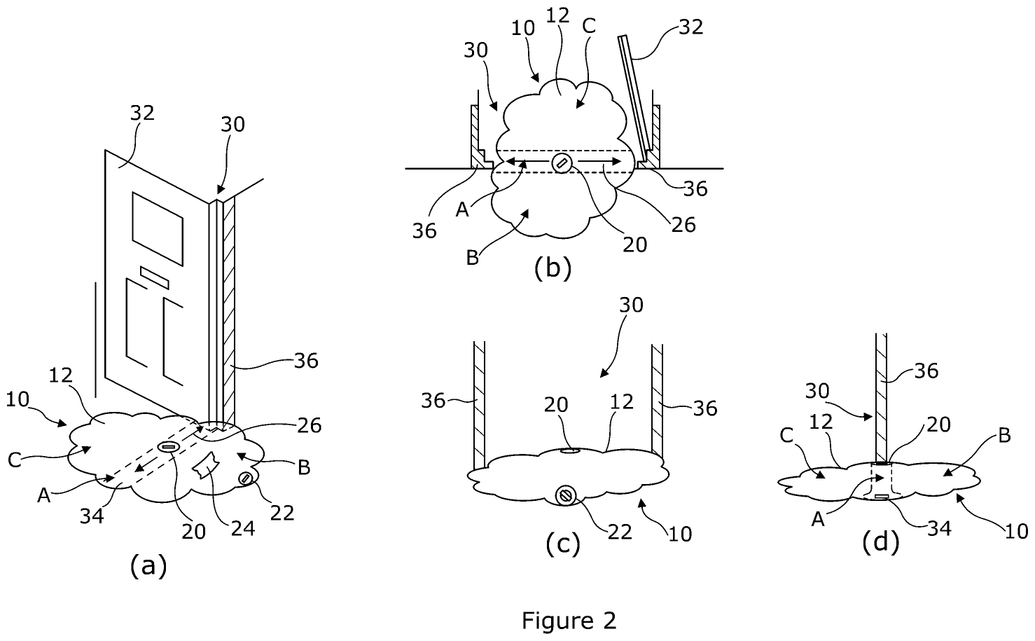

To deploy the bag 10, the collapsed bag 10 is moved into position in a building opening, as shown in FIG. 2. In this example, the building opening comprises a doorway 30. The door 32 is opened and the bag 10 is placed on the floor, across the threshold 34 of the doorway 30 and between the side posts or jambs 36 of the frame of the doorway 30.

The collapsed bag 10 is arranged so that the filling port 20 is uppermost and the drain port 22 on the front of the bag is facing towards the outside the property. The label 24 can help a user to identify the position of the drain port 22, which may be difficult to see when the bag 10 is in the collapsed state. The bag 10 is approximately centred in the doorway 30, so that the widest part of the bag 10 is positioned between the jambs 36 of the door frame. The arrows 26 help the user to position the bag 10 correctly in this respect. When arranged in this way, a central strip of the base panel 14 of the bag 10 rests on the threshold 34, and the remaining parts of the base panel 14 rest on the floor or ground to the front and rear of the threshold 34 (i.e. on the outside and inside of the doorway 30).

Once the bag 10 has been suitably positioned, a hose (not shown) is connected to the filling port 20. The hose is used to supply water to the internal volume 18 of the bag 10 from a suitable source. Conveniently for this purpose, the end of the hose remote from the bag is fitted with a tap connector to allow the hose to be connected directly to a nearby tap.

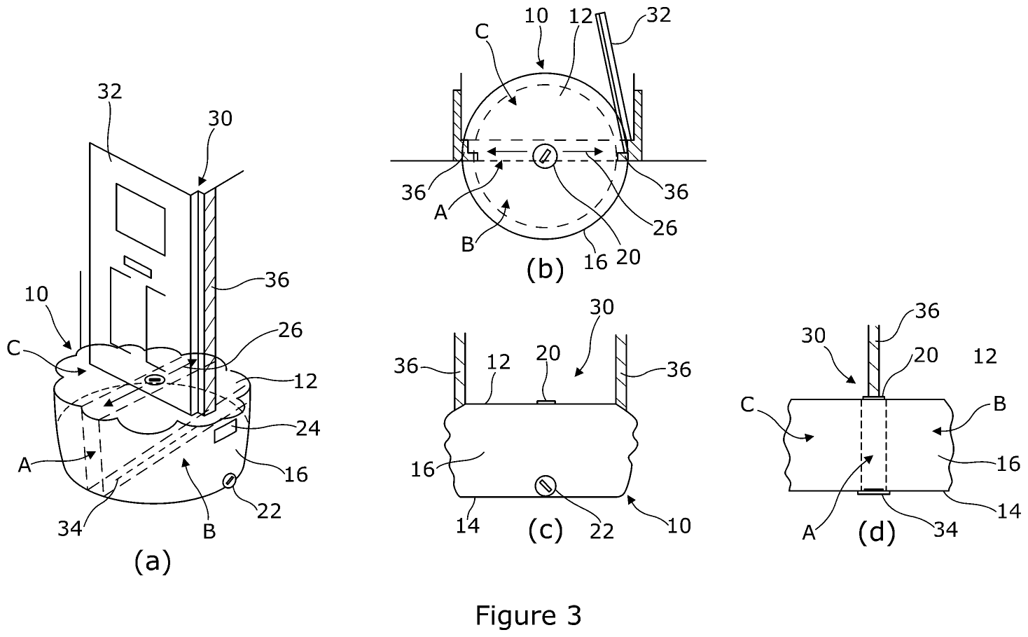

Referring to FIG. 3, when water is introduced through the filling port 20, the bag 10 gradually expands to accommodate the water. As filling proceeds, the height of the bag 10 increases so that the top panel 12 of the bag 10 rises. At the same time, the sidewall 16 of the bag 10 expands radially outwards. Because the material of the bag 10 is flexible, the sidewall 16 of the bag 10 conforms closely to the shape of the jamb 36, as best seen in FIG. 3(b). The base panel 14 of the bag also conforms to the shape of the threshold 34. The front and rear parts of the bag 10 stand on the ground or floor on the outer and inner sides of the threshold 34 respectively to stabilise and anchor the bag 10 in the doorway 30.

When in place, the bag 10 can be considered to have to have three functional regions, indicated by the dashed lines in FIG. 2 and labelled A, B and C. The central slice of the bag 10 that spans across the width of the doorway 30 and conforms to and seals against the doorway 30 under the hydrostatic pressure of the filling water defines a sealing region A. Thus the sealing region A extends across the width or diameter of the bag 10 and includes the vertical midplane indicated by the arrows 26. The remainder of the bag 10 defines two buttress regions B, C, which are disposed on the front and rear sides of the sealing region A and rest on the ground adjacent to the doorway 30.

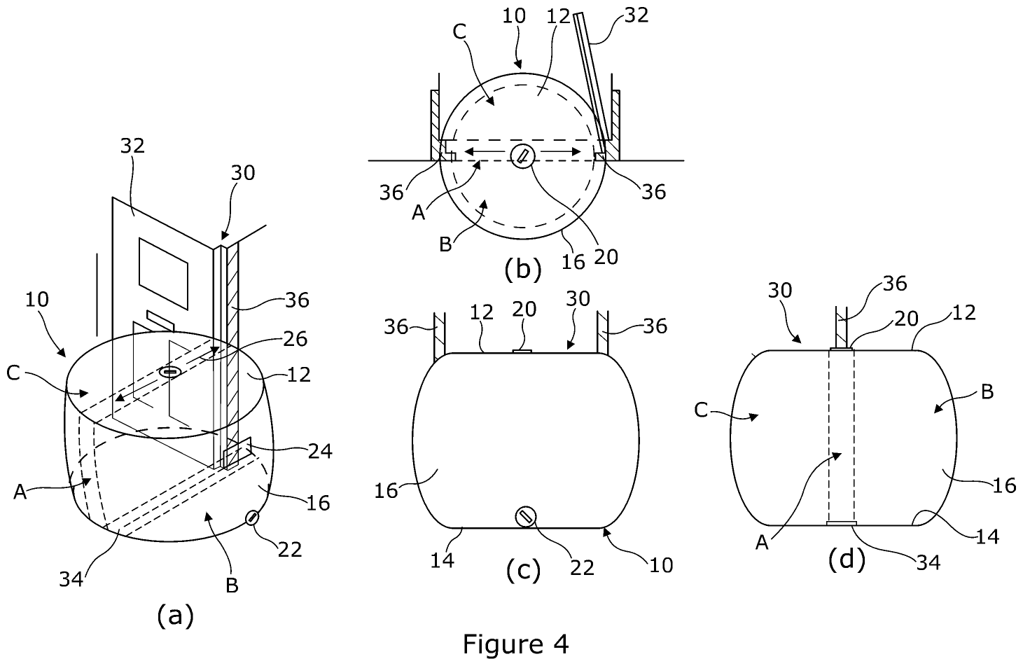

FIG. 4 shows the bag 10 in its fully expanded state, after it has been completely filled with water. At this point, if desired, the hose can be removed and the filling port 20 can be closed. The bag 10 extends approximately half-way up the doorway 30, forming an effective barrier against flood water up to that height.

When fully filled with water, the bag 10 weighs approximately one metric tonne, and this weight stops the bag 10 from being forced out of the doorway 30 even when a considerable depth of flood water acts on the front of the bag 10. In particular, the weight of water in the buttress regions B, C, which acts on the ground or floor on either side of the threshold 34, serves to anchor the bag 10 in position and prevents displacement of the sealing region A. In a similar manner, the high inertia of the bag 10 resists displacement of the bag 10 during transient loading conditions.

The mass of the water in the internal volume 18 of the bag 10 also creates a substantial hydrostatic pressure that acts on the sidewall 16 and the base panel 14 to press the material of the bag 10 into sealing contact with the jambs 36 and the threshold 34 on the sides and base respectively of the sealing region A.

Depending on the width and construction of the doorway 30, the material of the bag 10 may also conform to surfaces adjacent to the jambs 36 and the threshold 34, such as surfaces of the frame casing and the wall in which the doorway 30 is set, as well as steps, mullions, stops, weather strips, hinges and other components that form part of or are adjacent to the door frame. By virtue of the hydrostatic pressure acting upon the material of the bag 10, seals can be formed against any such surface irrespective of the orientation of the surface with respect to the bag 10. The base panel of the bag 10 will also readily conform to accommodate changes in floor level on either side of the threshold 34. For these reasons, the bag 10 will form an effective barrier in substantially any doorway 30, even if the initial positioning of the bag 10 is not accurate.

Once the threat of flooding has passed, the bag 10 can be removed from the doorway 30 by opening the drain port 22. This causes the water in the bag 10 to drain out of the internal volume 18, so that the bag 10 collapses. The position of the drain port 22 on the front of the bag 10 means that the water is expelled on the outside of the property. Also, because the drain port 22 is close to the base of the bag 10, substantially all of the water will drain under gravity. The collapsed bag 10, now with a substantially reduced weight, can then easily be removed from the doorway 30, preferably by first lifting the rear side of the bag 10 (i.e. the part on the inside of the property) to allow any remaining water to drain from the drain port 22. The collapsed bag 10 can then be cleaned if necessary, and stored for re-use.

Whilst FIGS. 2 to 4 illustrate a common application of the bag 10, it will be appreciated that the bag 10 could be used in different ways and in different situations. For example, the bag 10 could be used to provide a temporary barrier in other building openings, such as windows and hatches. The bag 10 could also be used to block a gateway or other opening in an external wall. Two or more bags 10 could be arranged side-by-side to provide a wider barrier.

The bag 10 does not need to be fully expanded to be effective in blocking the building opening. As the bag 10 is filled, the filling water will expand the bag 10 from the base upwards, so that the height of the effective barrier in the building opening increases during filling. Once the height of the filling water in the bag 10 is sufficiently far above the expected flood water level, filling of the bag 10 can be stopped. If necessary, the bag 10 could be topped up to increase the height of the effective barrier, for example in response to a rising flood water level.

The filling and drain ports 20, 22 can be of any suitable type. For instance, one or both ports may comprise an aperture in the bag, a tubular body that is disposed in the aperture and sealed to the material of the bag around the periphery of the aperture, and a closure for closing the body to seal the port. The closure may, for example, be in the form of a cap that is threaded for engagement with corresponding a corresponding thread formed on the body, or a bung that is a frictional fit in the body. The closure is preferably tethered to the body to prevent loss of the closure. A closure for the filling port is useful in preventing spillage of filling water from the bag, but it is conceivable that the closure could be omitted from the filling port so that the filling port remains open during use of the apparatus.

In a simple embodiment, the filling port 20 simply provides a hole into which a hose can be inserted. In this case, a length of hose, typically 1 m or more, is fed into the bag through the filling port so that the hose does not come free from the bag under the pressure of water during filling. A rubber gasket or insert may be provided in the filling port to grip the hose and, optionally, to close the hole when the hose is removed. With this arrangement, the hose may not form a tight seal in the filling port, so that air can be expelled through gap between the hose and the port.

Alternatively, the filling port 20 could include a hose connector, such as a push-fit connector of a type commonly known in the art. In arrangements where the hose forms a seal with the filling port, a separate vent arrangement may be provided to allow the expulsion of air from the internal volume as the bag is filled. For example, the vent arrangement may be a one-way valve disposed on the top panel on the bag, and may by integrated with or separate from the filling port.

The drain port 22 may also be fitted with a hose connector, so that the filling water can be directed into a drain or away from the immediate vicinity of the property if required.

It is also conceivable that the drain port could be omitted. Although less convenient, in some situations the bag could be drained through the filling port, for example using a pump or syphon. Alternatively, if the bag is not to be re-used, the bag could be drained by puncturing or cutting the bag to allow the water to drain away.

It will be understood that the arrows 26 and the label 24 are simply examples of indicators that could be provided to assist the user in identifying the front of the bag and the midplane for optimum placement of the bag in the building opening. Any suitable means for assisting the user in this respect could be provided, including text labels, graphics, symbols, colourways, and so on. Indicators may be printed on to the material of the bag, affixed to the bag (for example by adhesive or welding), incorporated into the material of the bag or provided in any other suitable way. Any suitable number of indicators could be provided, and the indicators may be disposed on any of the surfaces of the bag. The provision of any such indicators may be optional, for example if the orientation of the bag can be readily identified by the shape of the bag and the position of the drain port.

For domestic use, the bag may be supplied in a kit that includes a filling hose and a universal-type tap connector, to allow rapid deployment of the apparatus and filling of the bag from a domestic tap with no further equipment being required. Alternatively, a garden hose or any other suitable hose could be used.

Most conveniently, the bag is filled with clean water supplied from a domestic mains supply. It will be appreciated, however, that the water could be sourced from any other convenient supply, such a fire hydrant, stand pipe, storage tanker, bowser, water course, well or borehole, where suitable pumping and transfer equipment is available. Sea water, rainwater or grey water could also be used where suitable quantities are available. Even flood water could be used to fill the bag, although the risk of contamination in such situations may prevent subsequent re-use of the bag. The filling medium could be a liquid other than water. The bag would also function to block the building opening if filled with a granular flowable filling medium, such as sand, gravel, soil and so on, although the use of such materials could make emptying of the bag considerably more difficult.

The cylindrical shape of the bag 10, as described above, is preferred, since this minimises the number and length of seams required to form the bag 10, and therefore reduces the cost of manufacture and the risk of leakage. It will be understood that, in this example, the sidewall 16 is formed as a straight-walled tube, and the hydrostatic pressure of the filling water causes the sidewall 16 to bulge outwardly, such that the expanded bag adopts a barrel shape as shown in FIG. 1.

However, the bag could have any suitable shape. For example, the bag could be shaped as a barrel, as an elliptical cylinder, or as a cuboid with a square or oblong cross section in plan view. Preferably, the depth of the bag (i.e. the distance between its front and rear sides) is approximately equal to the width of the bag, so that the total volume of the bag is substantially larger than the volume of the sealing region.

Any suitable material can be used for the bag 10. The material should be watertight and, more preferably, gas-tight. Preferably, the material is substantially non-elastic (i.e. with a relatively high elastic modulus) to resist stretching when the bag is filled with water and has a high enough tensile strength to avoid rupture, but is sufficiently flexible to conform closely to the shape of the building opening. This may be achieved by forming the bag from a relatively thin but strong material. The material should also be resistant to damage by puncture or tearing. The material is preferably weldable, so that the sidewall and the top and base panels of the bag can be sealed to one another by welding.

One example of a suitable material is biaxially-oriented polyethylene terephthalate (also known as BoPET). However, other materials, such as polyester, polyethylene, polyvinyl chloride and rubber materials, may also be suitable. Multi-layered and composite materials could also be used.

Most conveniently, the entire bag 10 is made from the same material. However, it is conceivable that the bag 10 could be constructed from two or more different materials, for example to optimise the material properties of different parts of the bag 10. For instance, the top and/or base panels 12, 14 of the bag could be made form a different material to the sidewall 16. In another example, a different material could be used for part of the bag that will contact the building opening to form the sealing region A of the bag 10 could be made from a different material to that which will form the buttress regions B, C.

As will be understood by the a person skilled in the art, further modifications and variations not explicitly described above are also possible without departing from the scope of the invention as set out in the appended claims.

1. Flood protection apparatus for temporarily blocking a building opening to guard against the ingress of flood water, comprising a collapsible bag formed from a watertight conformable material and having a filling means for admitting a flowable filling medium to the bag to expand the bag from a collapsed state;
wherein, when the bag is disposed in the building opening in the collapsed state and filled with the filling medium, the bag conforms to and seals against a periphery of the building opening under the pressure of the filling medium to define a sealing region of the bag that spans across the building opening and a pair of buttress regions disposed on front and rear sides of the sealing region, and wherein the weight of the filling medium in the buttress regions acts to prevent displacement of the bag from the building opening.

2. Flood protection apparatus according to claim 1, wherein the bag includes a drain means for draining the filling medium from the bag to collapse the bag for release from the building opening.

3. Flood protection apparatus according to claim 2, wherein the drain means comprises a closable port.

4. Flood protection apparatus according to claim 2, wherein the drain means is disposed on a front part of the bag.

5. Flood protection apparatus according to claim 4, comprising a visual indication to denote the front part of the bag.

6. Flood protection apparatus according to claim 1, comprising a visual indication to denote a midplane of the bag.

7. Flood protection apparatus according to claim 1, wherein the bag has a width of at least 1 m when the bag is expanded.

8. Flood protection apparatus according to claim 1, wherein the distance between a frontmost point and a rearmost point of the bag is substantially equal to the width of the bag when the bag is expanded.

9. Flood protection apparatus according to claim 8, wherein the bag is generally cylindrical.

10. Flood protection apparatus according to claim 1, wherein the bag comprises a substantially continuous internal volume.

11. Flood protection apparatus according to claim 10, wherein the internal volume of the bag is substantially uninterrupted.

12. Flood protection apparatus according to claim 1, wherein the bag is self-supporting when filled with the filling medium.

13. Flood protection apparatus according to claim 1, wherein the bag comprises a base panel and a top panel connected to the base panel by a sidewall.

14. Flood protection apparatus according to claim 13, wherein the filling means is disposed on the top panel of the bag.

15. Flood protection apparatus according to claim 1, wherein the filling means comprises a closable filling port.

16. Flood protection apparatus according to claim 1, wherein the bag comprises vent means for the release of air.

17. Flood protection apparatus according to claim 1, wherein the material of the bag comprises a polymeric sheet material.

18. Flood protection apparatus according to claim 1, further comprising a filling hose cooperable with the filling means and connectable to a water supply.

19. Flood protection apparatus according to claim 18, comprising a domestic water tap connector.

20-22. (canceled)

23. A method of temporarily blocking a building opening to guard against the ingress of flood water, comprising:
arranging a bag in a collapsed state in the building opening, the bag being formed from a watertight conformable material, and
filling the bag with a flowable filling medium to expand the bag;
such that the bag conforms to and seals against the periphery of the building opening to define a sealing region of the bag that spans across the building opening and a pair of buttress regions of the bag disposed to the front and rear sides of the building opening.

24-28. (canceled)
